(19) United States
(12) Patent Application Publication
(10) Pub. No.: US 2004/0080870 A1
(43) Pub. Date: Apr. 29, 2004

(54) Disc cartridge and method of producing the same

(75) Inventor: Fumihito Imai, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/689,743

(22) Filed: Oct. 22, 2003

(30) Foreign Application Priority Data
Oct. 24, 2002 (JP) 309816/2002
Apr. 30, 2003 (JP) 125081/2003

(51) Int. Cl. G11B 23/03

(52) U.S. Cl. 360/133

(57) ABSTRACT

A disc cartridge includes a disc type recording medium housed for rotation in a flat housing formed by a pair of metal shell halves. The housing is provided with an opening for giving a recording/reproducing head of a disc driver access to the disc type recording medium. At least one of the metal shell halves is provided along its periphery with an erected wall which is formed by bending a part of the edge of the shell half and is bonded to the other shell half and a V-shaped groove which keeps the bending angle of the erected wall at a predetermined angle is integrally formed on the shell half.

### BACKGROUND OF THE INVENTION

1. Field of the Invention

This invention relates to a disc cartridge comprising a magnetic disc housed for rotation in a housing having an opening and a shutter for opening and closing the opening, and a method of producing the same.

2. Description of the Related Art

In mobile instruments such as a digital camera, there has been used as the recording medium, for instance, a subminiature magnetic disc cartridge called “clik! ®” shown in FIGS. 5A, 5B and 6. See, for instance, “Perso-Com Kaitai Shinsho” by Atsushi Oshima, Softbank Publishing, Apr. 19, 2000 pps, 52 and 53. The disc cartridge 1 (FIG. 6) can be loaded in a card-type driver (not shown) of type ΠPC employed in a notebook size personal computer. The driver is 53 mm×85 mm ×5 mm respectively in width, depth and thickness, and can be inserted for recording and reproduction into a PC card slot of a notebook size personal computer with a clik loaded therein.

FIG. 6 is a perspective view showing the, and FIG. 7 is an exploded perspective view of the same. The magnetic disc cartridge (“clik! ®”) 1 comprises a 40 MB magnetic disc 9 (FIG. 7) 45.7 mm (1.8 inches) in diameter housed for rotation in a flat housing 5 formed by a resin frame 2 and upper and lower shell halves 3 and 4. Each of the upper and lower shell halves 3 and 4 is formed of metal material (a stainless steel plate about 0.2 mm thick) and the flat housing is 50 mm in width, 55 mm in depth and 1.95 mm in thickness.

The housing 5 is provided with an opening 6 (FIG. 6) which gives access to the magnetic disc 9 to a magnetic head of a disc drive system into which the magnetic disc cartridge 1 is inserted, and a rotary shutter 7 formed of, for instance, aluminum alloy, which is moved between its closed position where it closes the opening 6 and its open position where it opens the opening 6. As shown in FIG. 6, the upper and lower shell halves 3 and 4 have peripheral walls 3k and 4k which are butted against each other and welded together by laser welding at not less than 10 sites P (FIG. 6).

The rotary shutter 7 comprises upper and lower shutter halves 7U and 7D and is supported for rotation between the upper and lower shell halves 3 and 4. Liners 18 are interposed between the magnetic disc 9 and the upper shutter half 7U and between the magnetic disc 9 and the lower shutter half 7D. The magnetic disc 9 is provided with a center core 10. The frame 2 is interposed between the upper and lower shell halves 3 and 4 to keep a predetermined space therebetween. A coiled spring 14 which urges the rotary shutter 7 toward its closed position and a guide wire 13 which is inserted into the coiled spring 14 to guide the same are disposed along the arcuate inner surface of the frame 2.

A shutter lock member 11 for locking the rotary shutter 7 in its closed position is provided on the upper shell half 3. A circular central opening 4a for giving access to a center core 10 of the magnetic disc 9 and an arcuate slit 4b concentric with the rotary shutter 7 are formed in the lower shell half 4. A shutter knob 7b which projects outward through the slit 4b to be moved along the arcuate slit 4b when the rotary shutter 7 is opened and closed is fixed to the lower shutter half 7D.

The upper and lower shutter halves 7U and 7D have peripheral walls 7Uk and 7Dk which are butted against each other and bonded together by welding or the like.

When the disc cartridge 1 is loaded in a personal computer, the rotary shutter 7 is rotated to its open position where it exposes the magnetic disc 9 through the opening 6 to give access to the magnetic disc 9 to a magnetic head of the computer to record or read data.

In addition to the “click!”, there has been known a rectangular flat magnetic disc cartridge which is employed in a type Π, PC card. (See, for instance, Japanese Unexamined Patent Publication No. 2001-243736.) The disc cartridges of this type comprises a rectangular flat base plate of resin holding therein a magnetic disc medium and a pair of metal cover plates disposed on opposite sides of the base plate. The cover plates are provided with peripheral walls which are bonded together by spot welding or the like.

When a cylindrical projection as a tubular shaft for rotatably supporting the rotary shutter 7 is to be formed in a thin sheet metal member such as the upper and lower shell halves 3 and 4 of the housing 5, a method of processing generally called “barring” is employed.

FIGS. 8A to 8E are for illustrating an example of barring employed when a projection is formed in a sheet metal. A base hole 51 of a small diameter is first formed in a sheet metal member 50 (e.g., one of the shell halves 3 and 4) as shown in FIG. 8A. Then a barring tool 60 comprising cylindrical smaller and larger diameter portions 61 and 63 provided on opposite end portions of a conical body portion 62 which is a truncated cone in shape is prepared and the smaller diameter portion 61 of the tool 60 is inserted into the base hole 51 as shown in FIG. 8B.

When the tool 60 is subsequently forced upward, a part 52 of the sheet metal member 50 circumscribing the base hole 51 is expanded as shown in FIG. 8C as the conical body portion 62 enters the base hole 51. When the tool 60 is further forced upward with the part about the base hole 51 held by a jig 65 having a circular opening 65a, the part 52 of the plate member 50 is further expanded and stretched to be plastically deformed as the larger diameter portion 63 enters the hole 51 as shown in FIG. 8D. The sheet metal member 50 is thus processed to a member having a cylindrical projection 53 with a central opening 54 as shown FIG. 8E. Though not shown, the jig 65 shown in FIG. 8D is also used in the steps shown in FIGS. 8B and 8C.

The cylindrical projection 53 is used as a tubular shaft for supporting the rotary shutter 7 for rotation. In such a case, after a plate member 55 having an axial opening 55a (e.g. one of the upper and lower shutter halves 7U and 7D) is loosely fit on the cylindrical projection 53 as shown in FIG. 9A, the free end portion of the cylindrical projection 53 is caulked to form a flange 53a for preventing dismounting of said plate member 55 from the cylindrical portion 53 as shown in FIG. 9B.

When the free end portion of the cylindrical projection 53 is caulked, a caulking jig 70 such as shown in FIG. 10 is generally employed. The caulking jig 70 comprises a lower die 71 and an upper die 72. The lower die 71 is provided with a flat upper surface 71a on which the sheet metal member 50 is placed, and a locator cylindrical body 73 on which the central opening 54 of the cylindrical projection 53 is fitted is erected from the upper surface 71a.

The upper die 72 is provided on its lower surface 72a with a cylindrical body 74 which is coaxial with, is shorter than and is of the same diameter as the cylindrical body 73 of the lower die 71. The diameter of a root portion of the cylindrical body 74 is curvedly enlarged toward the lower surface 72a, thereby forming a caulking wall surface 75.

When the flange 53a is formed on the free end portion of the cylindrical projection 53, the upper die 72 is moved downward with the plate member 55 having the axial opening 55a loosely fitted on the cylindrical projection 53 and with the cylindrical bodies 73 and 74 of the caulking jig 70 inserted into the central opening 54 from below and above, whereby the free end portion of the cylindrical projection 53 is expanded by the caulking wall surface 75 and a flange 53a is formed on the free end portion of the cylindrical projection 53.

However, production of the housing and/or the shutter of the disc cartridge in accordance with the prior art gives rise to the following problem. That is, bending of sheet metal to form parts of disc cartridge, e.g., metal shell halves, metal shutter and the like, causes a phenomenon of spring back in erected walls. It is difficult to control the spring back and to bend the sheet metal through a desired right angle, which results in increased labor. When the spring back cannot be successfully controlled, inclination of the erected walls, strain of the surface around the erected wall and/or the like can be generated.

Recently, miniaturization of systems such as a portable personal computer, a digital camera and a PC card are required and accordingly, miniaturization of a disc cartridge which is employed in such systems as a recording medium is required. In order to meet such requirements, the disc cartridge must be precisely formed of a thin sheet metal. As the thickness of the sheet metal becomes smaller, inclination of the erected walls, strain of the surface around the erected wall and/or the like become more apt to be generated. When such defect is generated, there arises fear that the disc cartridge cannot be loaded in the system. Further, inclination of the erected walls can reduce the rigidity of the disc cartridge.

Further, in the case of a cylindrical projection 53 which is employed as a tubular shaft for supporting for rotation the rotary shutter 7, the flange 53a for preventing dismounting of the shutter 7 is formed on the free end portion of the cylindrical projection 53 by caulking. However, the free end portion of the cylindrical projection 53 cannot be always of an ideal shape shown in FIG. 9B but the peripheral wall of the cylindrical projection 53 is often inclined outward so that the cylindrical projection 53 becomes larger in diameter toward its free end to be brought into contact with the plate member 55 to prevent rotation thereof as shown in FIG. 9C.

In order to avoid such trouble, conventionally, the speed of the upper die 72 has been controlled or the upper die 72 has been caused to work in an increased number of steps. However, these approaches have not been effective and the defect results in deterioration of the quality of the products and/or the yield of the products.

### SUMMARY OF THE INVENTION

In view of the foregoing observations and description, the primary object of the present invention is to provide a method of producing a disc cartridge which can suppress occurrence of spring back and strain of the surface around the erected wall and to provide a disc cartridge in which spring back and strain of the surface around the erected wall are suppressed.

Another object of the present invention is to provide a method of producing a disc cartridge in which when a cylindrical projection employed as a tubular shaft for supporting for rotation a rotary shutter is formed with a flange for preventing dismounting of the shutter on the free end portion thereof by caulking, inclination of the cylindrical projection can be prevented.

In accordance with a first aspect of the present invention, there is provided a disc cartridge comprising a disc type recording medium housed for rotation in a flat housing which comprises a pair of metal shell halves and is provided with an opening for giving a recording/reproducing head of a disc driver access to the disc type recording medium, wherein at least one of the metal shell halves is provided along its periphery with an erected wall which is formed by bending a part of the edge of the shell half and is bonded to the other shell half and an angle keeping means which keeps the bending angle of the erected wall at a predetermined angle is formed on the shell half integrally therewith.

In accordance with a second aspect of the present invention, there is provided a disc cartridge comprising a disc type recording medium housed for rotation in a flat housing which comprises a pair of metal shell halves and is provided with an opening for giving a recording/reproducing head of a disc driver access to the disc type recording medium, and a shutter for opening and closing the opening, wherein the shutter is formed by a pair of metal shutter halves, at least one of the shutter halves is provided along its periphery with an erected wall which is formed by bending a part of the edge of the shutter half and is bonded to the other shutter half and an angle keeping means which keeps the bending angle of the erected wall at a predetermined angle is formed on the shutter half integrally therewith.

The angle keeping means may be, for instance, a groove which is V-shaped in cross-section and formed along the inner side of the erected wall.

Otherwise, the angle keeping means may be a triangular rib which is embossed on the inner side of the erected wall substantially in perpendicular thereto.

In accordance with a third aspect of the present invention, there is provided a method of producing a disc cartridge comprising a disc type recording medium housed for rotation in a flat housing which comprises a pair of metal shell halves and is provided with an opening for giving a recording/reproducing head of a disc driver access to the disc type recording medium, wherein the improvement comprises that when forming an erected wall, which is bonded to the other shell half, on at least one of the shell halves by bending a part of the edge of the shell half, both the sides of the shell half are held under a pressure by a jig, along the part along which the shell half is bent to form the erected wall, so that the sides are not pulled toward the erected wall to be deformed upon bending the shell half.

In accordance with a fourth aspect of the present invention, there is provided a method of producing a disc cartridge comprising a disc type recording medium housed for rotation in a flat housing which comprises a pair of metal shell halves and is provided with an opening for giving a recording/reproducing head of a disc driver access to the disc type recording medium, and a shutter for opening and closing the opening, wherein the improvement comprises that the shutter is formed by a pair of metal shutter halves, and when forming an erected wall, which is bonded to the other shutter half, on at least one of the shutter halves by bending a part of the edge of the shutter half, both the sides of the shutter half are held under a pressure by a jig, along the part along which the shutter half is bent to form the erected wall, so that the sides are not pulled toward the erected wall to be deformed upon bending the shutter half.

For example, the jig may comprise a bending punch having a protrusion which extends along the erected wall and presses a side of the sheet metal (the shell half or the shutter half) adjacent to the inner side of the erected wall and a flat surface which is substantially flush with the side of the sheet metal, and a bearer which is positioned on the side of the sheet metal opposite to the bending punch.

In accordance with a fifth aspect of the present invention, there is provided a method of producing a disc cartridge comprising a disc type recording medium housed for rotation in a flat housing which comprises a pair of metal shell halves and is provided with an opening for giving a recording/reproducing head of a disc driver access to the disc type recording medium, and a rotary shutter which is for opening and closing the opening and is formed by a pair of shutter halves, wherein the improvement comprises that when a cylindrical projection is formed on one of the housing and the rotary shutter and a free end portion of the cylindrical projection is caulked with the other of the housing and the rotary shutter engaged for rotation with the cylindrical projection, thereby forming a flange for preventing disengagement of said the other of the housing and the rotary shutter from the cylindrical projection, a groove which is V-shaped in cross-section and extends in a circumferential direction of the cylindrical projection is formed on the peripheral surface of the cylindrical projection at the base of the flange prior to the caulking.

The cylindrical projection may be formed, for instance, by barring.

In the disc cartridge in accordance with the first aspect of the present invention, the angle keeping means prevents spring back of the erected wall of the shell half and suppresses strain of the surface around the erected wall.

In the disc cartridge in accordance with the second aspect of the present invention, the angle keeping means prevents spring back of the erected wall of the shutter half and suppresses strain of the surface around the erected wall.

When the angle keeping means is a groove which is V-shaped in cross-section and formed along the inner side of the erected wall, spring back of the erected wall is prevented and at the same time bending of the shell half or the shutter half is facilitated.

When the angle keeping means is a triangular rib which is embossed on the inner side of the erected wall substantially in perpendicular thereto, spring back of the erected wall is prevented and at the same time the erected wall is reinforced by the triangular rib, whereby the bending angle of the erected wall can be kept at a predetermined angle more surely.

In the method of producing a disc cartridge in accordance with the third aspect of the present invention, since both the sides of the shell half are held under a pressure by a jig, along the part along which the shell half is bent to form the erected wall, so that the sides are not pulled toward the erected wall to be deformed upon bending the shell half, deformation of the surface around the erected wall involved by formation the erected wall is prevented.

In the method of producing a disc cartridge in accordance with the fourth aspect of the present invention, since both the sides of the shutter half are held under a pressure by a jig, along the part along which the shutter half is bent to form the erected wall, so that the sides are not pulled toward the erected wall to be deformed upon bending the shutter half, deformation of the surface around the erected wall involved by formation of the erected wall is prevented.

When the jig comprises a bending punch having a protrusion which extends along the erected wall and presses a side of the sheet metal (the shell half or the shutter half) adjacent to the inner side of the erected wall and a flat surface which is substantially flush with the side of the sheet metal, and a bearer which is positioned on the side of the sheet metal opposite to the bending punch, the sides by the erected wall can be more strongly pressed and accordingly, deformation of the surface can be prevented more surely.

In the method of producing a disc cartridge in accordance with the fifth aspect of the present invention, the groove facilitates formation of the flange and prevents inclination of the cylindrical projection involved by caulking of the free end portion of the cylindrical projection. Accordingly, contact between the cylindrical projection and the member to be supported for rotation by the cylindrical projection (the shutter or the housing) can be avoided, whereby the yield and the quality of the of the products can be improved and the cost of the products can be reduced.

### BRIEF DESCRIPTION OF THE DRAWINGS

FIG. 1A is a fragmentary cross-sectional view showing a part of the peripheral wall erected on an edge of the lower shell half of a magnetic disc cartridge in accordance with a first embodiment of the present invention together with the jig,

FIG. 1B is a fragmentary plan view of the part of the peripheral wall of the lower shell half of the magnetic disc cartridge in accordance with the first embodiment of the present invention,

FIG. 2A is a fragmentary cross-sectional view showing an edge of the lower shell half of a magnetic disc cartridge in accordance with a second embodiment of the present invention before an erected wall is formed,

FIG. 2B is a fragmentary cross-sectional view of the same after the erected wall is formed,

FIG. 3 is a fragmentary perspective view of a magnetic disc cartridge in accordance with a third embodiment of the present invention showing the erected wall of the same,

FIG. 4A is a fragmentary cross-sectional view showing the lower shell half after bumping,

FIG. 4B is a fragmentary plan view showing the same after bumping,

FIGS. 5A and 5B are view illustrating formation of a flange by caulking on the free end portion of a cylindrical projection of a disc cartridge in accordance with a fourth embodiment of the present invention,

FIG. 6 is a perspective view of a disc cartridge,

FIG. 7 is an exploded perspective view of the disc cartridge shown in FIG. 6,

FIGS. 8A to 8E are views for illustrating the barring,

FIGS. 9A and 9B are cross-sectional views illustrating formation of a flange by caulking on the free end portion of a cylindrical projection of a disc cartridge in accordance with the prior art,

FIG. 9C is a cross-sectional view for illustrating the problem involved by the conventional caulking, and

FIG. 10 is a cross-sectional view of the caulking jig.

### DESCRIPTION OF THE PREFERRED EMBODIMENT

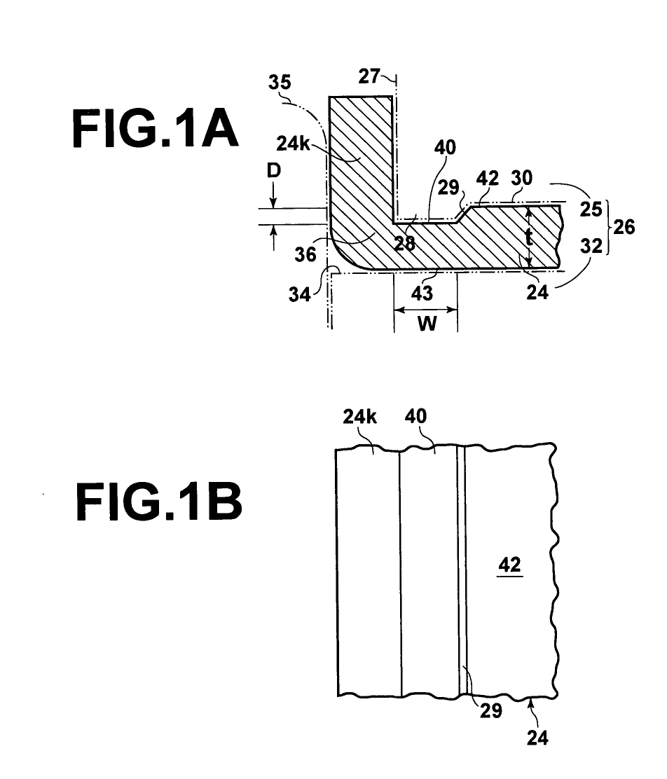

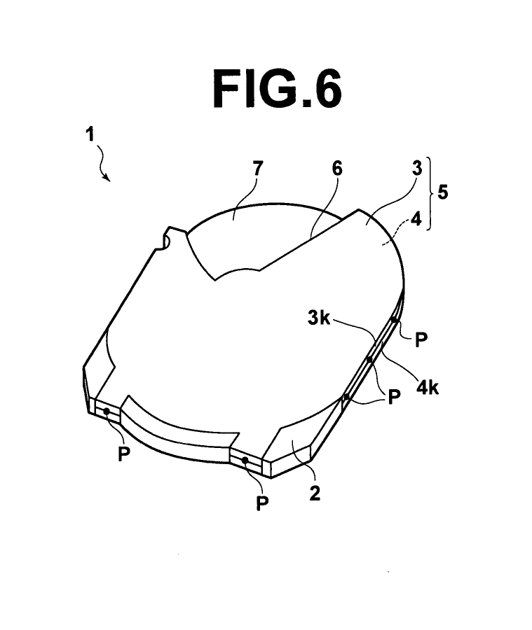

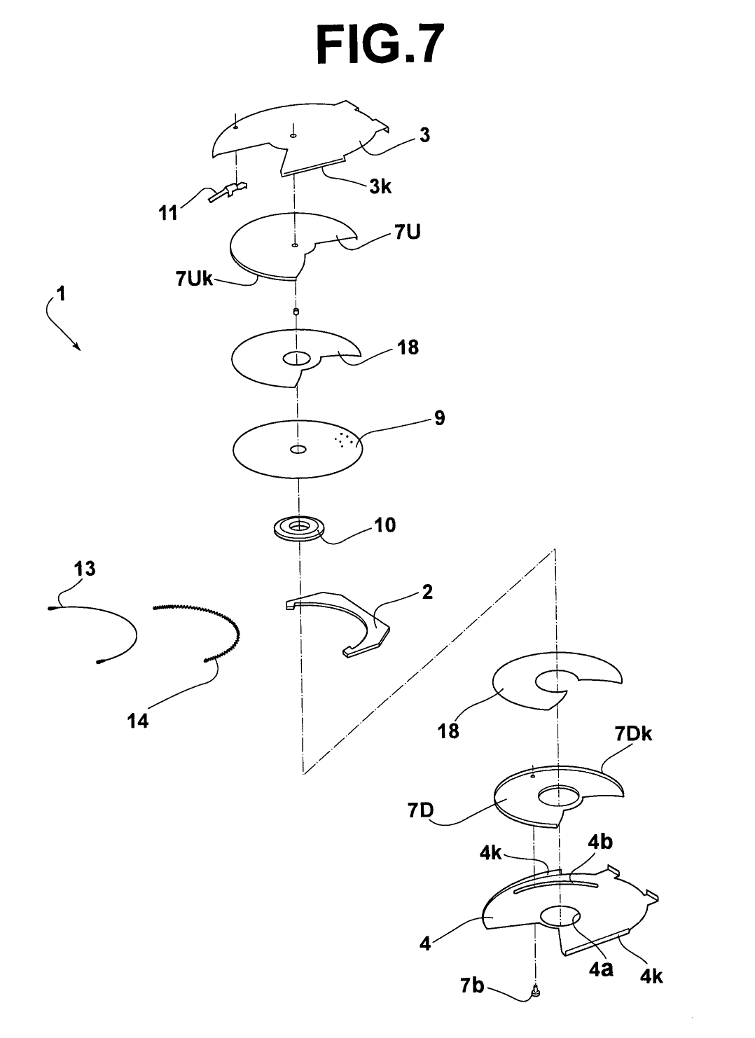

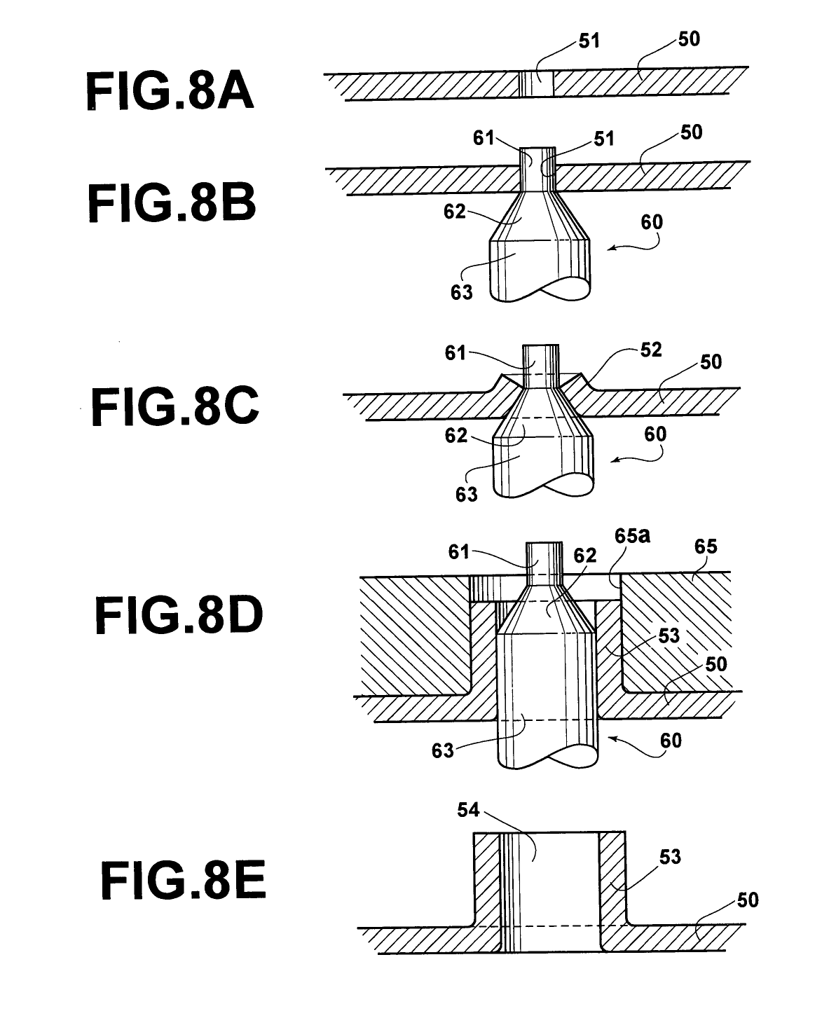

A disc cartridge in accordance with a first embodiment of the present invention will be described with reference to FIGS. 1A and 1B, hereinbelow. FIG. 1A is a fragmentary cross-sectional view showing a peripheral wall (erected wall) 24k erected on en edge of the lower shell half 24 of the disc cartridge in accordance with the first embodiment together with the jig employed, and FIG. 1B is fragmentary plan view of the lower shell half 24. The structure of the disc cartridge of this embodiment is basically the same as that shown in FIGS. 6 and 7 and will not be described here.

In the first embodiment, the jig 26 shown by the chained line in FIG. 1A is employed when the lower shell half 24 is bent. The jig 26 comprises a bending punch 25 and a bearer 32. The bending punch 25 comprises a vertical surface 27 extending to press the lower shell half 24, a protrusion 28 which projects from the base of the vertical surface 27 in perpendicular to the vertical surface 27 and extends along the vertical surface 27, and a flat surface 30 which projects from the edge of the protrusion 28 in perpendicular to the vertical surface 27 with an inclined shoulder 29 intervening between the protrusion 28 and the flat surface 30 and extends along the protrusion 28. In this particular embodiment, the bearer 32 has a flat surface 34 facing upward.

When bending the lower shell half 24 by the jig 26, the lower shell half 24 is inserted between the bending punch 25 and the bearer 32, and the lower shell half 24 is located with respect to the bending punch 25 so that bending punch 25 extends along the bending part 36 along which the lower shell half 24 is to be bent to form the peripheral wall (erected wall) 24k. Then the bending punch 25 is moved toward the bearer 32 and presses the upper surface 42 of the lower shell half 42, whereby the protrusion 28 of the bending punch 25 compresses the upper surface 42 of the lower shell half 24 to form a groove 40. Substantially simultaneously with the compression, a bending jig 35 bends upward the edge of the lower shell half 24 to form the peripheral wall 24k.

The groove 40 is formed by compressing the lower shell half 24 within the range of height of the shoulder 29. By this compression, the upper and lower surfaces 42 and 43 of the lower shell half 24 are held between the bending punch 50 and the bearer 32 and the surface around the peripheral wall 24k is prevented from being pulled toward the peripheral wall 24k when the lower shell half 24 is bent to form the peripheral wall 24k, whereby the peripheral wall 24k can be precisely formed and there is no fear that the upper and lower surfaces 42 and 43 of the lower shell half 24 are deformed. This method is effective to prevent deformation of the arcuate slit 4b of the lower shell half 24 shown in FIG. 6. Though being continuous in the embodiment described above, the protrusion 28 may be discontinuous. When the protrusion 28 is discontinuous, the groove 40 formed also becomes discontinuous.

It is preferred that the depth D of the groove 40 be ⅕ to ¼ of the thickness t of the lower shell half 24 and the width W of the groove 40 be substantially the same as the thickness t of the lower shell half 24.

Though, in the first embodiment, the present invention is applied to form the erected wall 24k of the lower shell half 24, the present invention may be applied to form the erected wall 3k of the upper shell half 3, the erected wall 7Uk of the upper shutter half 7U and the erected wall 7Dk of the lower shutter half 7D.

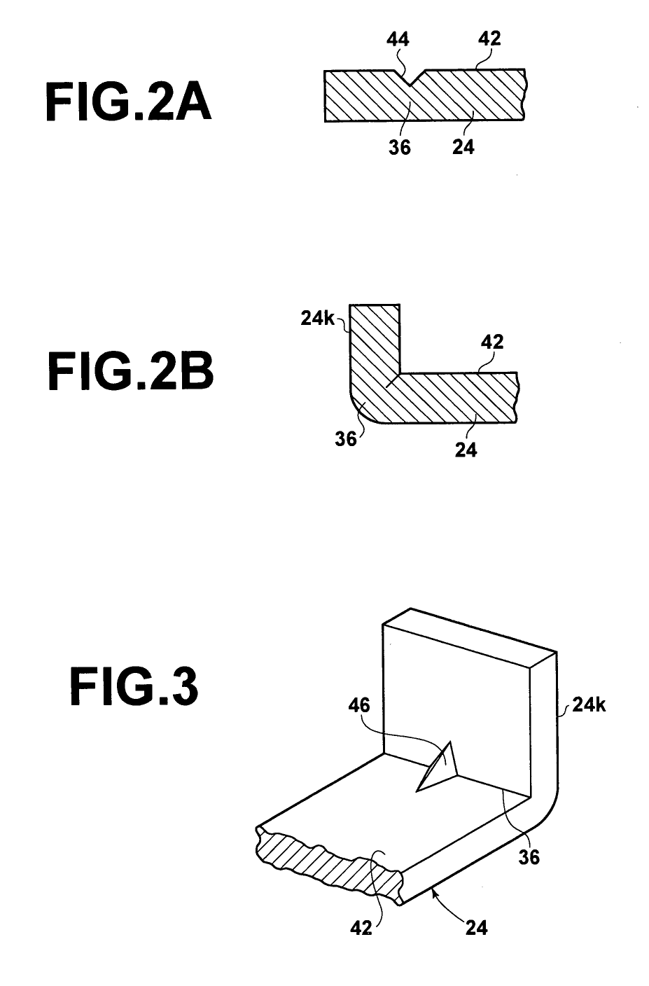

The disc cartridge in accordance with a second embodiment of the present invention will be described with reference to FIGS. 2A and 2B, hereinbelow.

FIGS. 2A and 2B are views for illustrating an erected wall of a disc cartridge in accordance with a second embodiment of the present invention. FIG. 2A is a fragmentary cross-sectional view showing an edge of the lower shell half of the magnetic disc cartridge in accordance with the second embodiment of the present invention before an erected wall is formed, and FIG. 2B is a fragmentary cross-sectional view of the same after the erected wall is formed. In FIGS. 2A and 2B, the elements analogous to those shown in FIGS. 1A and 1B are given the same reference numerals and will not be described here. In the disc cartridge of the second embodiment, a groove (an angle keeping means) 44 which is V-shaped in cross section is formed on the upper surface 42 of the lower shell half 24 along the bending part 36 along which the lower shell half 24 is to be bent to form the peripheral wall (erected wall) 24k. The groove 44 is angled by 90°, and accordingly when the edge of the lower shell half 24 is bent along the groove 44 by a jig not shown, the erected wall 24k is erected by 90° to the upper surface 42 of lower shell half 24 as shown in FIG. 2B.

In this second embodiment, when the lower shell half 24 is bent to form the erected wall 24k, material of the upper surface 42 is not pulled toward the erected wall 24k and the lower shell half 24 is easily bent. Accordingly, there is no fear that the surface around the erected wall 24k is deformed. Further, since the bending stress acting on the bending part 36 is small, the erected wall 24k can be kept at a right angle. It is preferred that the depth of the groove 44 be about ⅓ of the thickness of the sheet metal. Also in accordance with the second embodiment, the erected wall 3k of the upper shell half 3, the erected wall 7Uk of the upper shutter half 7U and the erected wall 7Dk of the lower shutter half 7D can be formed.

A third embodiment of the present invention will be described with reference to FIG. 3, hereinbelow. FIG. 3 is a fragmentary perspective view of the magnetic disc cartridge in accordance with the third embodiment of the present invention showing the erected wall 24k of the same. Also the third embodiment of the present invention will be described in conjunction with erecting a wall on the lower shell half 24. In this embodiment, a triangular rib (an angle keeping means) 46 is formed by embossment from outside at the bending part 36 when forming the erected wall 24k. When erected wall 24k is formed long along the bending part 36, a plurality of triangular ribs 46 may be formed at predetermined intervals.

Since the triangular rib 46 is formed integrally with the lower shell half 24 to connect the erected wall 24k and the upper surface 42 of the lower shell half 24, the rising angle of the erected wall 24k is surely held and at the same time, the erected wall 24k is greatly reinforced by the rib 46.

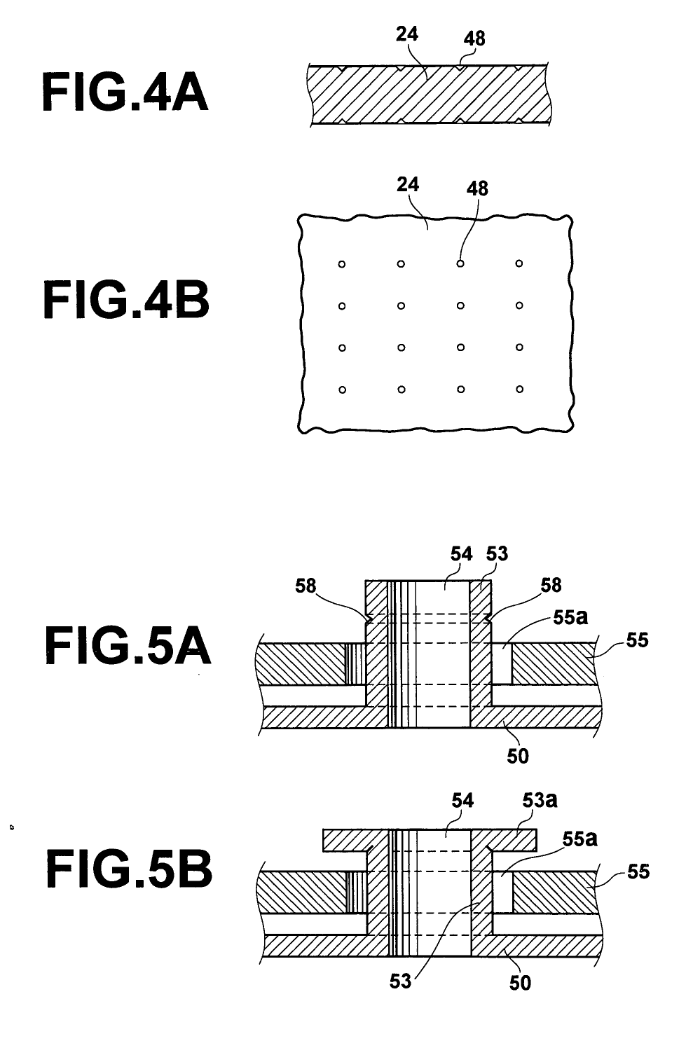

In order to improve the flatness of the upper and lower surfaces 42 and 43 of the lower shell half 24, a number of recesses may be formed on the upper and lower surfaces 42 and 43 by bumping at predetermined intervals as shown in FIGS. 4A and 4B.

Generally, a workpiece such as a sheet metal deteriorates in its flatness as the processing step progresses. Bumping is carried out for maintaining the flatness of the workpiece, and in the bumping, a member having a number of two-dimensionally erected pointed projections is pressed against both the surfaces of the sheet metal to form a number of fine conical recesses 48 thereon. It is preferred that the depth of each of the recesses 48 be 0.2 times the thickness t of the sheet metal and the space between adjacent recesses 48, i.e., the pitch of the recesses 48, be 0.7 to 2 times the thickness t of the sheet metal. It is further preferred that the angle which the inner surface of each of the recesses 48 be 90° to 120°. When such bumping is carried out before forming the erected walls 3k, 4k, 7Uk 7Dk, the orthogonality of these erected walls can be stabilized.

A fifth embodiment of the present invention will be described with reference to FIGS. 5A and 5B, hereinbelow.

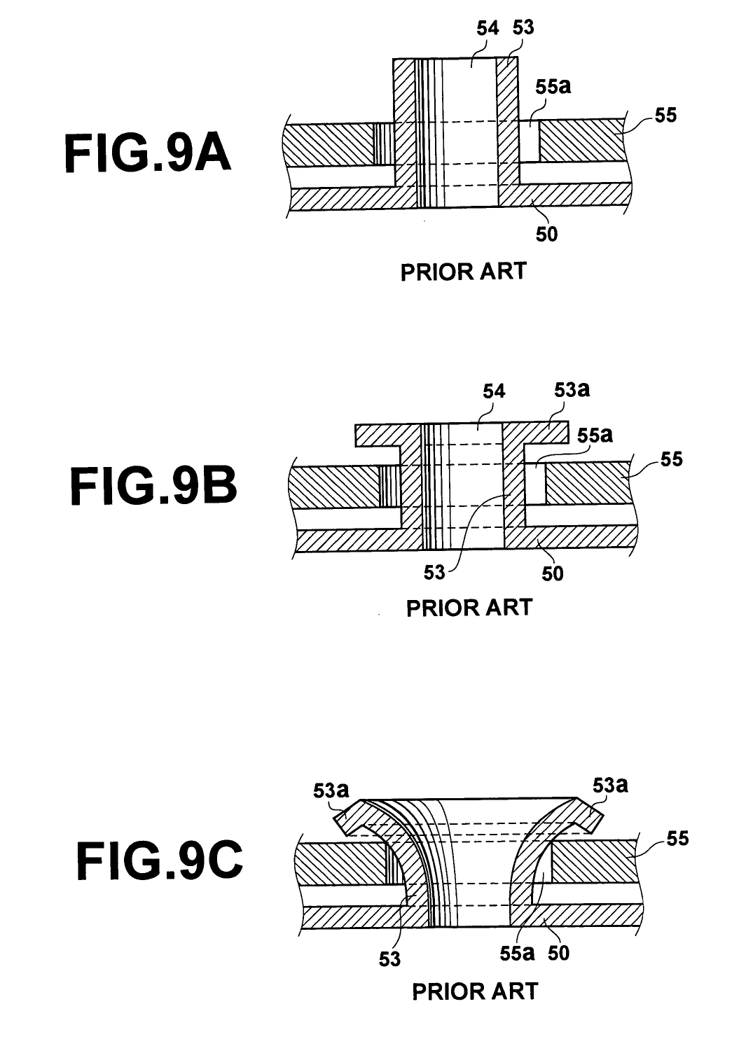

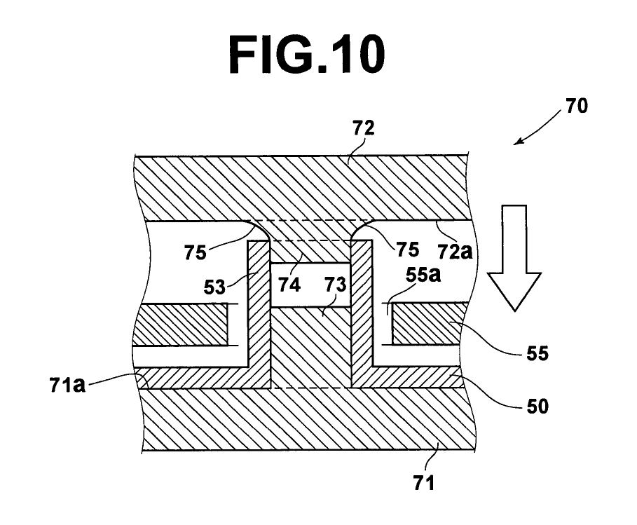

FIGS. 5A and 5B are views for illustrating formation of a flange 53a by caulking on the free end portion of a cylindrical projection 53 formed on one 50 of the upper and lower shell halves with one 55 of the shutter halves of the rotary shutter 7 fitted for rotation on the cylindrical projection 53, thereby preventing disengagement of the shutter half 55 from the cylindrical projection 53. FIGS. 5A and 5B respectively correspond to FIGS. 9A and 9B for illustrating formation of a flange 53a by caulking in accordance with the prior art. In FIGS. 5A and 5B, elements analogous to those shown in FIGS. 9A and 9B are given the same reference numerals and will not be described here. In the fourth embodiment, a groove 58 which is V-shaped in cross-section and extends in a circumferential direction of the cylindrical projection 53 is formed on the peripheral surface of the cylindrical projection 53 at the base of the flange 53a as shown in FIG. 5A prior to the caulking.

When the free end portion of the cylindrical projection 53 is caulked in this state, the flange 53a for preventing disengagement can be formed on the free end of the cylindrical projection 53 without inclination of the cylindrical projection 53.

Though, in the fourth embodiment, the cylindrical projection 53 for supporting for rotation the rotary shutter 7 is formed on one of the shell halves of the housing 5, the cylindrical projection 53 may be formed on one of the shutter halves of the rotary shutter 7.

Though, the present invention has been described in detail with reference to the first to fourth embodiments, the embodiments are given only for describing the present invention and may be variously modified. In view of the availability, processability and strength of the disc cartridge produced, it is preferred that the sheet metal material for forming the shell halves be a stainless steel sheet which is 0.15 to 0.2 mm in thickness (SUS304), and the sheet metal material for forming the shutter halves be an aluminum alloy sheet which is 0.15 to 0.2 mm in thickness (A5052P). Especially preferably, the sheet metal material for forming the shell halves is a stainless steel sheet which is 0.2 mm in thickness, and the sheet metal material for forming the shutter halves is an aluminum alloy sheet which is 0.15 mm in thickness.

What is claimed is:

1. A disc cartridge comprising a disc type recording medium housed for rotation in a flat housing which comprises a pair of metal shell halves and is provided with an opening for giving a recording/reproducing head of a disc driver access to the disc type recording medium, wherein
at least one of the metal shell halves is provided along its periphery with an erected wall which is formed by bending a part of the edge of the shell half and is bonded to the other shell half and an angle keeping means which keeps the bending angle of the erected wall at a predetermined angle is formed on the shell half integrally therewith.

2. A disc cartridge as defined in claim 1 in which the angle keeping means is a groove which is V-shaped in cross-section and formed along the inner side of the erected wall.

3. A disc cartridge as defined in claim 2 in which the angle keeping means is a triangular rib which is embossed on the inner side of the erected wall substantially in perpendicular thereto.

4. A disc cartridge comprising a disc type recording medium housed for rotation in a flat housing which comprises a pair of metal shell halves and is provided with an opening for giving a recording/reproducing head of a disc driver access to the disc type recording medium, and a shutter for opening and closing the opening, wherein the shutter is formed by a pair of metal shutter halves, at least one of the shutter halves is provided along its periphery with an erected wall which is formed by bending a part of the edge of the shutter half and is bonded to the other shutter half and an angle keeping means which keeps the bending angle of the erected wall at a predetermined angle is formed on the shutter half integrally therewith.

5. A disc cartridge as defined in claim 4 in which the angle keeping means is a groove which is V-shaped in cross-section and formed along the inner side of the erected wall.

6. A disc cartridge as defined in claim 4 in which the angle keeping means is a triangular rib which is embossed on the inner side of the erected wall substantially in perpendicular thereto.

7. A method of producing a disc cartridge comprising a disc type recording medium housed for rotation in a flat housing which comprises a pair of metal shell halves and is provided with an opening for giving a recording/reproducing head of a disc driver access to the disc type recording medium, wherein the improvement comprises that when forming an erected wall, which is bonded to the other shell half, on at least one of the shell halves by bending a part of the edge of the shell half, both the sides of the shell half are held under a pressure by a jig, along the part along which the shell half is bent to form the erected wall, so that the sides are not pulled toward the erected wall to be deformed upon bending the shell half.

8. A method as defined in claim 7 in which the jig comprises a bending punch having a protrusion which extends along the erected wall and presses a side of the shell half adjacent to the inner side of the erected wall and a flat surface which is substantially, flush with the side of the shell half, and a bearer which is positioned on the side of the shell half opposite to the bending punch.

9. A method of producing a disc cartridge comprising a disc type recording medium housed for rotation in a flat housing which comprises a pair of metal shell halves and is provided with an opening for giving a recording/reproducing head of a disc driver access to the disc type recording medium, and a shutter for opening and closing the opening, wherein the improvement comprises that the shutter is formed by a pair of metal shutter halves, and when forming an erected wall, which is bonded to the other shutter half, on at least one of the shutter halves by bending a part of the edge of the shutter half, both the sides of the shutter half are held under a pressure by a jig, along the part along which the shutter half is bent to form the erected wall, so that the sides are not pulled toward the erected wall to be deformed upon bending the shutter half.

10. A method as defined in claim 9 in which the jig comprises a bending punch having a protrusion which extends along the erected wall and presses a side of the shutter half adjacent to the inner side of the erected wall and a flat surface which is substantially flush with the side of the shutter half, and a bearer which is positioned on the side of the shutter half opposite to the bending punch.

11. A method of producing a disc cartridge comprising a disc type recording medium housed for rotation in a flat housing which comprises a pair of metal shell halves and is provided with an opening for giving a recording/reproducing head of a disc driver access to the disc type recording medium, and a rotary shutter which is for opening and closing the opening and is formed by a pair of shutter halves, wherein the improvement comprises that when a cylindrical projection is formed on one of the housing and the rotary shutter and a free end portion of the cylindrical projection is caulked with the other of the housing and the rotary shutter engaged for rotation with the cylindrical projection, thereby forming a flange for preventing disengagement of said the other of the housing and the rotary shutter from the cylindrical projection, a groove which is V-shaped in cross-section and extends in a circumferential direction of the cylindrical projection is formed on the peripheral surface of the cylindrical projection at the base of the flange prior to the caulking.

12. A method as defined in claim 11 in which the cylindrical projection is formed by barring.
